(19) United States
(12) Patent Application Publication
(10) Pub. No.: US 2006/0068354 A1
(43) Pub. Date: Mar. 30, 2006

(54) Orthodontic device

(76) Inventor: Norbert Jeckel, Freiburg (DE)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/232,546

(22) Filed: Sep. 22, 2005

(30) Foreign Application Priority Data
Sep. 25, 2004 (DE) 102004046766.8

(51) Int. Cl. A61C 3/00

(52) U.S. Cl. 433/21

(57) ABSTRACT

An orthodontic device serves for orthodontic shifting of teeth, especially cheek teeth (molars). The device has, for this, anchoring points to fasten the device on the tooth being moved and on the remaining dental arch and with a pressure element applying compressive forces. The pressure element has a wire arch exerting a compressive force with at least one caudal segment and at least one cranial segment.

### CROSS-REFERENCE TO RELATED APPLICATION

This application claims priority to German Application Serial No. 102004046766.8 filed in Germany on Sep. 25, 2004.

### FIELD OF THE INVENTION

The invention concerns an orthodontic device for orthodontic shifting of teeth, especially cheek teeth (molars), with anchoring points to fasten the device on the tooth being moved and on the remaining dental arch and with a pressure element applying compressive forces to the anchoring points.

### BACKGROUND OF THE INVENTION

In order to correct misplaced teeth, dental splints have already been developed in which, for example, there is an attachment to the No. 6 tooth, which is connected by a support arch with brackets to the front teeth of the same jawbone. A turning spring, for example, can be arranged on the dental arch, which applies pressure to the No. 6 tooth and its attachment. This application of pressure produces the desired movement of the rear tooth and, thus, the required correction of the defective tooth position. The already known state of the art is also familiar under the term “movement on the arch.”

Since the attachment of the compressed No. 6 tooth has to move along the dental arch, unwanted tilting and thus an impairment of the corrective action may occur. Since the attachment has a purchase relatively far up on the tooth, but since the so-called center of resistance of the tooth is more in the lower region—at the root bifurcation—an unwanted tilting action (inclination) and a corresponding torquing are additionally generated on the tooth being manipulated.

Forms of connection of a metal tube with a band, which is removably and firmly placed circularly around the molars so as to encompass a tooth and apply orthodontic forces to it, are prior art.

Various embodiments of splints and the like for stabilizing the residual front dental arch against the opposing forces are also prior art.

The problem is to create a device to enable a shifting of a tooth relative to the remaining dental arch with practically no disruptive tilting effect and/or disruptive torques during the treatment.

### SUMMARY OF THE INVENTION

To solve this problem, the invention proposes a pressure element having a wire arch exerting a compressive force with at least one caudal segment and at least one cranial segment.

With the present invention, the molars (thick cheek teeth) of patients can preferably be shifted in the distal direction (backward) within the upper jaw or lower jaw, depending on the treatment needs. The special benefit is that this can be done without cooperation from the patient, on both sides or also selectively on one side, with high quality of treatment. The special quality of treatment is due to the fact that the movement of the tooth occurs in conformity with the physical circumstances, i.e., axially correct and free of torsion, even though the orthodontic forces produced by the apparatus can only be applied eccentrically from the axis and at a definite distance from the center of resistance of the tooth in the region of the tooth root.

Due to the novel technical fabrication of the device, the opposing reciprocal forces at play as a secondary effect are kept as low as is technically possible. This is due to the fact that the tooth movement does not occur “on the arch,” but instead, “with the arch.” The transmission of force to the tooth and the three dimensionally controlled guidance of the tooth, especially thanks to an extensive torsion-stiffness of the wire arch during the movement, cooperate technically in the new apparatus. As a result, there are no frictional forces due to the conventional eccentric guidance of the tooth on a separate wire arch serving merely to guide the tooth. The conventional guidance always resulted in an uncontrollable inclination of the wire arch at the exit points of the guide tube, i.e., friction was produced during the movement of the tooth on the guiding arch. Due to the bracing of the orthodontal forces between molar and remaining dental arch, this friction would produce reciprocal forces that are undesirable and manifested by tooth movements in the other, i.e., mesial (forward) direction on the anterior (front) remaining dental arch.

Furthermore, the apparatus of the present invention enables a more “comfortable” wearing, and is not very noticeable from the outside. Furthermore, it is easy for the technician to manipulate it on the patient and it is economical in cost.

A preferred embodiment of the invention specifies that the wire arch is S-shaped and has two at least partly spring-elastic loops and one of the spring-elastic loops of the S-shape runs partly above the occlusal plane (cranially) and the other loop of the S-shape runs partially below the occlusal plane (caudally). The S-shaped loops are secured in the compressed state on the tooth being manipulated and on the remaining dental arch, so that the loops exert a compressive force on the tooth being manipulated as they strive to leave the compressed state and thus are braced against the remaining dental arch.

Another embodiment specifies that the wire arch has at least one arc-shaped, at least partly spring-elastic segment and at least one spiral-shaped, spring-elastic segment and one of the two segments runs partially above the occlusal plane (cranially) and the other segment runs partially below the occlusal plane (caudally).

The spring force of the loops can be further strengthened advantageously in that at least the segment of the wire arch running below the occlusal plane has a sheathing of rubber or elastic plastic or similar elastic material. A loop with an elastic rubber sheathed caudal segment (downwardly directed) below the occlusal plane is especially suitable to act on the center of resistance of the tooth and thereby assure an axially correct, physical movement of the molar. The elastic rubber sheathing serves to strengthen the action of this arch segment within the bioelastic wire arch loop.

It is advantageous that one of the anchoring points has an anchoring sleeve encompassing a tooth and the other anchoring point has an anchoring splint or a tooth crown.

It is advantageous that the anchoring sleeve is provided as a removable fastening on the tooth being manipulated and the other anchoring point with the anchoring splint or the tooth crown is provided for removable fastening on the remaining dental arch, preferably on the tooth next to the tooth being manipulated, the anchoring sleeve has one fastening point with a tube, in particular, for axially movable accommodation of the first free end of the wire arch, and the second free end of the wire arch is especially firmly anchored in the anchoring splint or on the tooth crown, preferably by screwing. A torsion-rigid configuration of the loops as well as the torsion-stable, removably firm anchoring of the loops both at the fastening point on the anchoring sleeve and on the anchoring splint at the remaining dental arch prevents uncontrollable movements of the molar, such as inclination or torquing, under the distallization force.

The torsion-rigid anchoring and the total elastic restoring force of the bioelastic arch portion also prevents a rotation of the molars during the manipulation, despite the eccentric application of force.

For an easy adjustment of the device before and during the tooth manipulation, it is advisable that the anchoring splint provided at the one anchoring point forms a shape-stable element, which is connected at its end facing the wire arch by means of a movable coupling, especially a slide bearing coupling, to the S-shaped wire arch. In this way, it is also possible to equalize the height between the anchoring point on the remaining dental arch and the anchoring splint and the loop during the tooth manipulation, without requiring a manual adjustment afterwards by the dentist.

A preferred embodiment specifies that a slotted screw with a tensioning nut is provided for fastening the anchoring splint on one tooth, the slotted screw has a connection element, especially a pad shaped one, for fastening the slotted screw, preferably with dental cement or similar adhesive, to the tooth in the remaining dental arch next to the tooth being manipulated, and the anchoring splint engages with the slot of the screw and can be adjusted lengthwise and also fastened by means of the tension nut.

Thanks to the adjustability of the anchoring splint in the lengthwise direction, the bracing of the wire arch can be adjusted and also fine-tuned in the course of the orthodontal procedure. The connection element can consist of a metal gridwork adaptable to the outer shape of the tooth, on which the dental cement or similar fastening material can be applied. Such a fastening of the anchoring splint is economical and can easily be removed afterwards for adjustment.

It is advantageous that the anchoring splint is held form-fitted in the slotted screw in the direction of rotation and accordingly has a cross section departing from a rotationally symmetrical shape and preferably an oval or polygon cross section at least in its segment engaging with the slot of the slotted screw. The anchoring splint as soon as it is inserted into the screw slot is already held form-fitting in the direction of rotation about its lengthwise axis, so that the system practically stabilizes itself. By tightening the tension nut, the anchoring splint is clamped and held in the lengthwise direction. For this, a relatively slight clamping force is enough, since the anchoring splint is held form-fitting in the direction of rotation and no clamping force is required for this.

For high torsion stiffness of the wire arch, it is advantageous that the wire of the arch has a rectangular or oval cross section, i.e., preferably a cross section which is not rotationally symmetrical.

The device of the invention will be prepared as a treatment aid in the dental laboratory. On a plaster model of the corresponding jaw of the patient, the anchoring sleeve is removably attached about the tooth being manipulated (distallized). A removable anchoring point is produced on the remaining dental arch for anchoring the reciprocal forces, and the shape-stable element formed by an anchoring splint will be fastened herein, with the pressure element removably connected to it. The anchoring splint can also be directly connected to a tooth of the remaining anterior dental arch.

The device is adjusted to the tooth and jaw anatomy of the patient so that the pressure element comes to lie free of tension between the connection at the fastening point on the molar and the removable anchoring on the remaining dental arch. One further checks to make sure that the pressure element does not disturb the neighboring teeth or jaw of the patient when under compression. The adjustment of the device is done by means of tools; the spring-elastic material of the loops can be partially deformed, and in particular bent by means of these tools (bioelasticity) and the loops can then be further elastically deformed and produce a spring force. The anchoring splint is likewise bent by means of the tools and thereby adjusted to the particular requirements.

On the patient himself, the anchoring sleeve is secured on the molar and the anchoring splint is secured with dental cement, or the anchoring splint is attached directly to a tooth in the remaining arch. The pressure element previously adjusted in the laboratory is then inserted in the fastening point of the molar and placed at first loosely in the anchoring point on the remaining dental arch. After activating the pressure element, i.e., after compression of the loops, the removably fixed anchoring to the remaining dental arch is produced.

Around four to six weeks after the orthodontal forces have been acting and the tooth has moved, so that the tension of the compressed loops has relaxed, the pressure element is reactivated in the same way, that is, it is compressed, and the force is again anchored on the remaining dental arch.

When properly indicated and if normal anatomical conditions exist, the device of the invention works reliably and always achieves the desired treatment outcome. Application can occur in the upper jaw, buccal (toward the cheek) or palatinal (toward the palate), and/or in the lower jaw, buccal (toward the cheek) or lingual (toward the tongue).

These and other features, advantages and objects of the present invention will be further understood and appreciated by those skilled in the art by reference to the following specification, claims and appended drawings.

### BRIEF DESCRIPTION OF THE DRAWINGS

FIG. 1 is a side view of a dental arch with a device according to the invention on a tooth being moved relative to the remaining dental arch, already slightly moved (distallized); and

FIG. 2 is a top view corresponding to FIG. 1.

### DETAILED DESCRIPTION OF THE PREFERRED EMBODIMENT

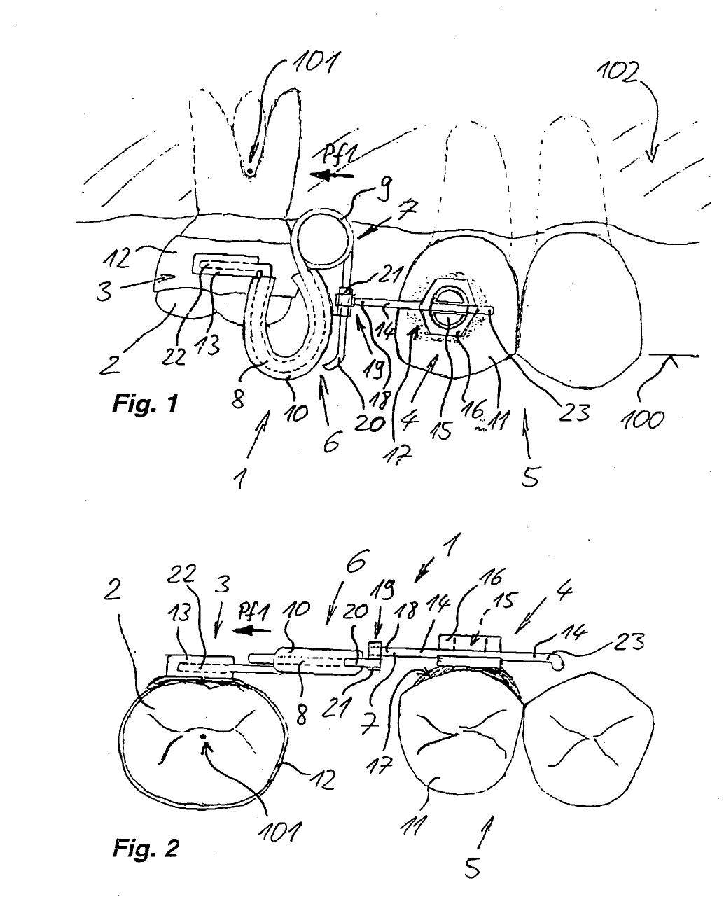

An orthodontal device denoted as a whole by 1 for orthodontal movement of teeth, especially cheek teeth (molars) 2, has, clearly noticeable in FIG. 1, anchoring points 3, 4 for fastening the device 1 on the tooth 2 being moved and on the remaining dental arch 5, relative to which the tooth 2 is being moved. Between the anchoring points 3, 4, there is a pressure element 6, which applies compressive forces (arrow Pf1) to the anchoring points 3, 4.

The application of the device 1 illustrated in the figures accomplishes a shifting of the tooth 2, already somewhat shifted relative to the remaining dental arch 5, in an upper jawbone 102 in the distal direction. However, the application of the device 1 in a very similar functional fashion can also occur in the upper jawbone 102 toward the palate (palatinal) or (not shown) in the lower jaw, toward the tongue (lingual) or toward the cheek (buccal).

As FIG. 1 shows, the pressure element 6 has an especially torsion-stiff wire arch 7, applying the compressive force Pf1, with a caudal segment (below the occlusal plane 100) and a cranial segment (above the occlusal plane 100). The wire arch 7 is S-shaped, and the caudal segment is formed by an at least partly spring-elastic, partially caudally directed loop 8 and the cranial segment is formed by an at least partly spring-elastic, partially cranially directed loop 9. The caudally directed loop 8 has a sheathing 10 of rubber-elastic material, in order to strengthen the spring force of the loop 8. This sheathing 10, when its length is appropriately dimensioned and/or the wire arch 7 is appropriately configured, can be arranged movably on the latter, in order to accomplish a transpositioning of the force of resistance and a different direction for the force components.

With the two loops 8, 9 each extending on different sides of the occlusal plane 100, one can achieve a movement of the tooth 2 relative to the remaining dental arch 5 without or with only very slight disruptive twisting and/or inclination/tilting relative to the occlusal plane 100 of the tooth 2 (“movement with the arch”), since the forces Pf1 acting on the tooth 2 are applied near a center of resistance 101, indicated by a dot in FIGS. 1 and 2. Previously known devices produced the forces acting on the tooth 2 primarily caudally (“movement at the arch”) and, thus, at greater distance from the center of resistance 101.

The example in the figures shows the moving of the No. 6 tooth 2 relative to the remaining dental arch 5, with one anchoring point 4 secured to the No. 5 tooth 11. The other anchoring point 3 has an anchoring sleeve 12 on the tooth 2, which embraces the tooth 2 at its circumference, as shown by the top view in FIG. 2. The anchoring sleeve 12 has a fastening point with a tube 13, in which one free end 22 of the loop 8 engages and is movably nested there.

The anchoring point 4 grasps the No. 5 tooth of the remaining arch, next to the tooth 2, by means of an anchoring splint 14 as a shape-stable element, which engages with a slotted screw 15 with a tensioning nut 16 and is firmly clamped there. The screw 15 has a sleeve or pad-like connection element 17 for fastening to the No. 5 tooth 11, which is connected to the No. 5 tooth 11 by means of dental cement. The connection element 17 can be, for example, a metal gridlike material adapted to the exterior shape of the tooth 11 or it can be adapted to the exterior shape of the tooth.

The anchoring splint 14 or similar shape-stable element is movably joined, as evident in FIG. 1, by its free end 18, away from the screw 15, by means of a slide bearing coupling 19 to a free end 20 of the cranial loop 9, so that spontaneously equalizing and in particular height-equalizing movements of the tooth 2 relative to the remaining dental arch 5 are possible during the movement of the tooth 2. For this, the slide bearing coupling 19 has a slide element 21, which is arranged torsion-proof and axially movable on the free end 20 of the cranial loop 9, and the free end 18 of the anchoring splint 14 is firmly joined radially to it.

For a torsion-proof movability of the slide piece 21 at the free end 20 of the cranial loop 9, it is advantageous for the wire arch 7 to have a rectangular or oval or similar rotationally nonsymmetrical cross section.

The segment of the anchoring splint 14 engaging in the slot of the slotted screw 15 can also have a cross section deviating from a rotationally symmetrical shape, for example, an oval or polygon cross section, so that the anchoring splint 14 is form-fitted in the screw slot to prevent twisting. The anchoring splint is held in the slot by the tension nut 16 and also secured in lengthwise direction by tightening it. To adjust and readjust the tension in the preferably S-shaped wire arch 7, the tension nut 16 is loosened somewhat and the anchoring splint 14 moved in the lengthwise direction. An unwanted twisting is prevented by the form fit, acting in this direction of movement.

The above description is considered that of the preferred embodiment only. Modification of the invention will occur to those skilled in the art and to those who make or use the invention. Therefore, it is understood that the embodiment shown in the drawings and described above is merely for illustrative purposes and not intended to limit the scope of the invention, which is defined by the following claims as interpreted according to the principles of patent law, including the doctrine of equivalents.

The invention claimed is:

1. An orthodontic device for orthodontic shifting of teeth, the teeth including anchoring points to fasten the device on a tooth being moved and on a remaining dental arch, the device comprising:
a pressure element configured to apply compressive forces to the anchoring points;
the pressure element having a wire arch for exerting a compressive force and including at least one caudal segment and at least one cranial segment.

2. The device of claim 1, wherein:
the wire arch is S-shaped and has two at least partly spring-elastic loops;
a first one of the spring-elastic loops of the S-shape being configured to run partly above an occlusal plane and a second one of the spring elastic loops of the S-shape being configured to run partially below the occlusal plane.

3. The device of claim 1, wherein:
the wire arch has at least one arc-shaped, at least partly spring-elastic segment and at least one spiral-shaped, spring-elastic segment;
a first one of the two segments being configured to run partially above an occlusal plane and a second one of the two segments being configured to run partially below the occlusal plane.

4. The device of claim 3, wherein:
at least the first one of the two segments of the wire arch configured to run below the occlusal plane has a sheathing of elastic material.

5. The device of claim 1, further including:
an anchoring sleeve for encompassing a first tooth at a first one of the anchoring points and an anchoring splint for connecting to a second tooth at a second one of the anchoring points.

6. The device of claim 5, wherein:
the anchoring sleeve is configured to be removably fastened on the tooth being moved; and
the anchoring splint is configured to be removably fastened on the remaining dental arch.

7. The device of claim 5, wherein:
the anchoring sleeve has one fastening point with a tube for axially movable accommodation of a first free end of the wire arch; and
a second free end of the wire arch is firmly anchored in the anchoring splint.

8. The device of claim 1, further including:
an anchoring sleeve for encompassing a first tooth at a first one of the anchoring points and a tooth crown for connecting to a second tooth at a second one of the anchoring points.

9. The device of claim 8, wherein:
the anchoring sleeve is configured to be removably fastened on the tooth being moved; and
the tooth crown is configured to be removably fastened on the remaining dental arch.

10. The device of claim 8, wherein:
the anchoring sleeve has one fastening point with a tube for axially movable accommodation of a first free end of the wire arch; and
a second free end of the wire arch is firmly anchored on the tooth crown.

11. The device of claim 5, wherein:
the anchoring splint forms a shape-stable element and includes an end facing the wire arch, the end being connected to the wire arch by a movable coupling.

12. The device of claim 11, wherein:
the movable coupling comprises a slide bearing coupling.

13. The device of claim 5, wherein:
a slotted screw with a tensioning nut is provided for fastening the anchoring splint on one tooth, the slotted screw having a connection element for fastening the slotted screw to the tooth in the remaining dental arch next to the tooth being moved, the anchoring splint engaging with a slot of the screw, the anchoring splint being lengthwise adjustable and fastened to the screw by the nut.

14. The device of claim 13, wherein:
the anchoring splint is held form-fitted in the slotted screw in a direction of rotation and has a non-circular cross section at least in its segment engaging with the slot of the slotted screw.

15. The device of claim 1, wherein:
a wire of the wire arch has a non-circular cross section.

16. A method of orthodontic shifting of teeth with anchoring points on a tooth being moved and on a remaining dental arch, the method comprising:
providing a device having a pressure element including a wire arch;
fastening the device on the tooth being moved and on the remaining dental arch;
applying a compressive force with the wire arch of the pressure element to the anchoring points; and
providing the wire arch with at least one caudal segment and at least one cranial segment.

17. The method of claim 16, wherein:
the wire arch is S-shaped and has two at least partly spring-elastic loops; and
further including running a first one of the spring-elastic loops of the S-shape partly above an occlusal plane and running a second one of the spring elastic loops of the S-shape partially below the occlusal plane.

18. The method of claim 16, wherein:
the wire arch has at least one arc-shaped, at least partly spring-elastic segment and at least one spiral-shaped, spring-elastic segment; and
further including running a first one of the two segments partially above an occlusal plane and running a second one of the two segments partially below the occlusal plane.

19. The method of claim 18, including:
sheathing at least the second one of the two segments with an elastic material.

20. The method of claim 16., further including:
encompassing a tooth of a first one of the anchoring point with an anchoring sleeve; and
anchoring a second one of the anchoring points with an anchoring splint.

21. The method of claim 20, further including:
removably fastening the anchoring sleeve on the tooth being moved; and
removably fastening the anchoring splint on the remaining dental arch.

22. The method of claim 21, wherein:
the remaining dental arch is a tooth next to the tooth being moved.

23. The method of claim 16, further including:
encompassing a tooth of a first one of the anchoring point with an anchoring sleeve; and
anchoring a second one of the anchoring points with a tooth crown.

24. The method of claim 20, further including:
removably fastening the anchoring sleeve on the tooth being moved; and
removably fastening the tooth crown on the remaining dental arch.

25. The method of claim 24, wherein:
the remaining dental arch is a tooth next to the tooth being moved.

26. The method of claim 20, further including:
fastening the anchoring splint to one tooth with a slotted screw having a tensioning nut, the slotted screw having a connection element for fastening the slotted screw to the tooth in the remaining dental arch next to the tooth being moved;
engaging the anchoring splint with a slot of the screw;
adjusting the anchoring splint lengthwise; and
fastening the anchoring splint using the tension nut.
